(19) United States
(12) Patent Application Publication
(10) Pub. No.: US 2008/0159559 A1
(43) Pub. Date: Jul. 3, 2008

(54) Post-filter for microphone array

(75) Inventors: Masato Akagi, Nomi-shi (JP); Junfeng Li, Sendai-shi (JP); Masaaki Uechi, Hadano-shi (JP); Kazuya Sasaki, Susono-shi (JP)

Correspondence Address: COOPER & DUNHAM, LLP, 1185 AVENUE OF THE AMERICAS, NEW YORK, NY, 10036, US

(73) Assignees: Japan Advanced Institute of Science and Technology; Toyota Jidosha Kabushiki Kaisha

(21) Appl. No.: 12/074,085

(22) Filed: Feb. 29, 2008

Related U.S. Application Data
(63) Continuation of application No. PCT/JP2006/317229, filed on Aug. 31, 2006.

(30) Foreign Application Priority Data
Sep. 2, 2005 (JP) 2005-255103

(51) Int. Cl. H04R 3/00

(52) U.S. Cl. 381/92; 381/122

(57) ABSTRACT

A post-filter includes a microphone array including at least two microphones to which a voice signal are input, a beam former which forms the voice signal input from the microphone array, a divider which divides a target sound containing noise input from the microphone array into at least two frequency bands at a predetermined frequency, a first filter which estimates the filter gain with the noise non-correlated between the microphones, a second filter which estimates a filter gain of one microphone of the microphone array or an average signal of the microphone array, an adder which adds the outputs from the first and second filters to each other, and a filter for reducing the noise based on the outputs from the adder and the beam former.

### CROSS-REFERENCE TO RELATED APPLICATIONS

This is a Continuation Application of PCT Application No. PCT/JP2006/317229, filed Aug. 31, 2006, which was published under PCT Article 21(2) in Japanese.

This application is based upon and claims the benefit of priority from prior Japanese Patent Application No. 2005-255103, filed Sep. 2, 2005, the entire contents of which are incorporated herein by reference.

### BACKGROUND OF THE INVENTION

1. Field of the Invention

The present invention relates to a post-filter for a microphone array.

2. Description of the Related Art

Many applications including cell phones and automatic voice recognition systems are desirably based on a hands-free technique due to its utility and flexibility. One of the critical problems for this technique is that the reliability of a signal received by a microphone located at a far point is extremely reduced by various types of noise. As a solution to this problem, the use of a spatial filter having a microphone array for suppressing noise arriving from a direction other than a predetermined direction is considered. The microphone array produces a high-quality speech signal and has considerable superiority in noise reduction.

A proposition made recently is described in Document 1: J. Bitzer, K. U. Simmer and K. D. Kammeyer, “Multi-microphone Noise Reduction Techniques as Front-end Devices for Speech Recognition”, Speech Communication, vol. 34, pp. 3-12, 2001. This proposition indicates that assuming that a desired speech signal and noise are not correlated, a multi-channel Wiener filter provides an optimum solution minimizing a square error of an output with respect to a broadband input. Also, Document 1 indicates that the multi-channel Wiener filter can be decomposed into a minimum variance distortionless response (MVDR) beam former and the following Wiener post-filter. Generally, the multi-channel Wiener filter generates an output with a signal-to-noise ratio higher than in the case where only the MVDR beam former is used. In the practical noise environment, therefore, the addition of post-filtering is required to improve the performance of the microphone array.

With regard to the aforementioned post-filtering, various post-filtering techniques have been proposed (Document 2: R. Zelinski, “A Microphone Array with Adaptive Post-filtering for Noise Reduction in Reverberant Rooms”, in Proc. IEEE Int. Conf. on Acoustic, Speech, Signal Processing, vol. 5, pp. 25782581, 1988., Document 3: I. A. McCowan and H. Bourlard, “Microphone Array Post-filter Based on Noise Field Coherence”, IEEE Trans. on Speech and Audio Processing, vol. 11, No. 6, pp. 709-716, 2003., Document 4: I. Cohen and B. Berdugo, “Microphone Array Post-filtering for Non-stationary Noise Suppression”, in Proc. IEEE Int. Conf. Acoustic Speech Signal Processing, pp. 901-904, May 2002., and Document 5: I. Cohen, “Multi-channel Post-filtering in Non-stationary Noise Environments”, IEEE Trans. Signal Processing, Vol. 52, No. 5, pp. 1149-1160, 2004). One multi-channel post-filter widely used was first proposed by Zelinski. This post-filter (hereinafter referred to as a “Zelinski post-filter”) assumes a noise field in which noise instances for different microphones are totally uncorrelated. This assumption, however, is rarely satisfied in the actual environment, or especially, in the case where microphones are located close to each other or in a low-frequency range high in correlation between noise instances.

In order to suppress the noise instances having a high correlation, a proposition has been made to couple a general sidelobe canceller (GSC) to a Zelinski post-filter (Document 6: S. Fischer, K. D. Kammeyer, and K. U. Simmer, “Adaptive Microphone Arrays for Speech Enhancement in Coherent and Incoherent Noise Fields”, in Proc 3rd joint meeting of the Acoustical Society of America and the Acoustical Society of Japan, Honolulu, Hi., 1996). It is pointed out, however, that both the GSC and the Zelinski post-filter have no satisfactory behavior in the low-frequency area. For this reason, it has been proposed to use the Zelinski post-filter to reduce low correlated noise components at high frequency and to conduct a spectral subtraction to reduce high correlated noise components at low frequency (Document 7: J. Meyer and K. U. Simmer, “Multi-channel Speech Enhancement in a Car Environment Using Wiener Filtering and Spectral Subtraction”, in Proc. IEEE Int. Conf. on Acoustic, Speech, Signal Processing, Munich, Germany, pp. 21-24, 1997). This proposition, however, contradicts with the basic configuration of the multi-channel Wiener post-filter on the one hand and requires a voice activity detector (VAD) for spectral subtraction on the other.

Now, the multi-channel Wiener post-filter and the problems to be solved are explained. After that, the Zelinski post-filter and the McCowan post-filter used for comparison are explained.

In a microphone array having M sensors in a noise environment, an mth observation signal xₘ(t) is formed of two components. A first signal is a desired one converted by an impulse response between a desired sound source and the mth sensor. A second signal is an additional noise nm(t). From this, the receive signal is given by Equation 1:

xₘ(t)=s(t)*aₘ(t)+nₘ(t) (1)

where m=1, 2, . . . ,M, and * is a convolution operator. By application of the short-time Fourier transform (STFT), a signal observed in time and frequency domains can be expressed as shown below:

X(k,l)=S(k,l)A(k)+N(k,l ) (2)

where k is a frequency index and l is a frame index

X^{T}(k,l)=[X₁(k,l), X₂(k,l), . . . , X_{M}(k,l)] (3)

A^{T}(k)=[A₁(k), A₂(k), . . . , A_{M}(k)] (4)

N^{T}(k,l)=[N₁(k,l), N₂(k,1), . . . , N_{M}(k,l)] (5)

The object here is to estimate the desired signal from the observed signals including the noise instances. By using this matrix expression, an estimated output signal T(k,l) is given by the equation below:

T(k,l)=W^{H}(k,l)×(k,l) (6)

where W(k,l) is a weight coefficient and the superscript H is a complex conjugate inversion.

In response to a request to minimize a mean square error between the desired signal and the estimation thereof, the optimum weight coefficient is obtained and so is the multi-channel Wiener filter. Assuming that the desired signal and the noise are not correlated, the multi-channel Wiener filter can be further decomposed into a MVDR beam former and a Wiener post-filter.

$$\begin{matrix}[ Expression 1 ] & \\ {W}_{opt} ( k , l ) = [ \frac{{Φ}_{nn}^{- 1} ( k , l ) A ( k )}{{A}^{H} ( k ) {Φ}_{nn}^{- 1} ( k , l ) A ( k )} ] \frac{{φ}_{ss}^{- 1} ( k , l )}{{φ}_{ss}^{- 1} ( k , l ) {φ}_{nn}^{- 1} ( k , l )} & ( 7 )\end{matrix}$$

In Equation 7, above, the first term represents the MVDR beam former, and the second term represents the Wiener post-filter. The MVDR beam former estimates the distortionless MMSE of the desired signal in a predetermined direction. By reducing the remaining noise further in the Wiener post-filter, the noise reduction capability can be improved to thereby generate a higher signal-to-noise ratio.

As the MVDR beam former, proposed are several adaptive algorithms such as a Frost beam former (Document 8: O. L. Frost, “An algorithm for linearly constrained adaptive array processing”, in Proc. IEEE, vol. 60, pp. 926-935, 1972) and a generally-used side lobe canceler (GSC) and several non-adaptive algorithms such as a super-directive beam former on the assumption of a diffused noise field.

The discussion below assumes that a microphone array is arranged in advance in a desired signal direction within a range not departing from the general applicability and in order to process the same desired voice signal on each microphone, the multi-channel input is scaled. In the process, a time delay compensation output is given as follows.

Xₘ(k,l)=S(k,l)+Nₘ(k,l) (m=1, 2, . . . , M) (8)

Now, two post-filters called the Zelinski post-filter and the McCowan post-filter are briefly explained.

The Zelinski post-filter provides a solution of the Wiener filter in the noise field where noise instances are completely non-correlated, using the autocorrelation spectral density and cross-correlation spectral density estimated. As long as the desired signal and the noise are not correlated, and the noise instances for different microphones, though identical in power density, are not correlated, then the autocorrelation and cross-correlation spectral densities φxᵢxᵢ(k,l) and φxᵢxⱼ(k,l) can be simplified.

φxᵢxᵢ(k,l)=φss(k,l)+φnn(k,l) (9)

φxᵢxⱼ(k,l)=φss(k,l) (10)

Based on the simplistic expression (Equations 9 and 10) of the autocorrelation and cross-correlation spectral densities, the Zelinski post-filter can be formulated:

$$\begin{matrix}[ Expression 2 ] & \\ {G}_{z} ( k , l ) = \frac{\frac{2}{M ( M - 1 )} {\sum }_{i = 1}^{M - 1} {\sum }_{j = i + 1}^{M} R \{ {φ}_{{x}_{i} {x}_{j}} ( k , l ) \}}{\frac{1}{M} {\sum }_{i = 1}^{M} {φ}_{{x}_{i} {x}_{i}} ( k , l )} & ( 11 )\end{matrix}$$

where the real number R{ } and the mean calculation (for all the sensor pairs) contribute to an improved tenacity of the post-filter against an estimation error. The autocorrelation and cross-correlation spectral densities can be estimated by the microphone signal scaled.

Actually, however, the basic assumption of the Zelinski post-filter that the noise instances for the respective microphones are not correlated is rarely satisfied in the practical environment. Taking this fact into consideration, McCowan has relaxed the assumption that the noise instances for the respective microphones are not correlated and has proposed an assumption that the noise instances for the respective microphones have the same power spectral density and are related to each other and that the magnitude of the correlation is given by a coherence function.

Then, under the assumption that the desired speech signal and the noise are not correlated and the relaxed assumption of the correlation between the noise instances, the autocorrelation and cross-correlation spectral densities of the multiple channels are given by the equations described below. In these equations, Γnᵢnⱼ(k,l) is a complex coherence function (described later in Equation 17).

φxᵢxᵢ(k,l), φxⱼxⱼ(k,l) and φxᵢxⱼ(k,l) can be simplified as follows.

φxᵢxᵢ(k,l)=φss(k,l)+φnn(k,l) (12)

φxⱼxⱼ(k,l)=φss(k,l)+φnn(k,l) (13)

φxᵢxⱼ(k,l)=φss(k,l)+Γnᵢnⱼ(k,l)φnn(k,l) (14)

Based on these expressions, the spectral density φss_(k,l) of the speech power providing the numerator of the Wiener post-filter can be expressed as

$$\begin{matrix}[ Expression 3 ] & \\ {φ}_{ss}^{( ij )} \_ ( k , l ) = \frac{R \{ {φ}_{{x}_{i} {x}_{j}} ( k , l ) - \frac{1}{2} R \{ {Γ}_{{n}_{i} {n}_{j}} ( k , l ) \} ( {φ}_{{x}_{i} {x}_{i}} ( k , l ) + {φ}_{{x}_{j} {x}_{j}} ( k , l ) )}{1 - R \{ {Γ}_{{n}_{i} {n}_{j}} ( k , l ) \}} & ( 15 )\end{matrix}$$

The McCowan post-filter can be expressed as

$$\begin{matrix}[ Expression 4 ] & \\ {G}_{M} ( k , l ) = \frac{\frac{2}{M ( M - 1 )} {\sum }_{i = 1}^{M - 1} {\sum }_{j = i + 1}^{M} {φ}_{ss}^{( ij )} \_ ( k , l )}{\frac{1}{M} {\sum }_{i = 1}^{M} {φ}_{{x}_{i} {x}_{i}} ( k , l )} & ( 16 )\end{matrix}$$

The McCowan post-filter presupposes the use of the multi-channel recording in an office, and is proposed to achieve an improved performance as compared with the Zelinski post-filter in this environment. The performance of the McCowan post-filter is expected to be reduced, however, in the presence of a difference between an estimated coherence function and the actual coherence function.

### BRIEF SUMMARY OF THE INVENTION

An object of the present invention is to provide a novel post-filter having a hybrid structure in a diffused noise field.

The diffused noise field like the environment in a reverberated room or vehicle compartments is proposed as a rational model of many practical noise environments. In the diffused noise field, low-frequency noise instances are correlated high and high-frequency noise instances are correlated low. Taking these characteristics into consideration, according to this invention, there are employed a multi-channel Wiener post-filter for high-frequency (correlated low) noise instances and a single-channel Wiener post-filter for low-frequency (correlated high) noise instances. In high-frequency regions, a corrected Zelinski post-filter sufficiently considering and utilizing the correlation between the noise instances for different microphone pairs is employed. In the low-frequency regions, on the other hand, a single-channel Wiener post-filter for further reducing the “musical noise” due to a decision directivity signal-to-noise ratio estimation mechanism is employed. The post-filter according to this invention theoretically has a basic configuration of the multi-channel Wiener post-filter and can effectively reduce the high correlated noise instances and low correlated noise instances in the diffused noise field.

The post-filter according to an aspect of the invention includes a microphone array having at least two microphones which are supplied with a voice signal, a beam former which forms the voice signal input from the microphone array, a divider which divides a target sound containing noise instances input from the microphone array into at least two frequency bands, a first filter which estimates a filter gain with the noise instances not correlated between the microphones, a second filter which estimates a filter gain of one microphone in the microphone array or a mean signal of the microphone array, an adder which adds the outputs of the first and second filters, and means for reducing the noise instances based on the outputs from the adder and the beam former.

### BRIEF DESCRIPTION OF THE SEVERAL VIEWS OF THE DRAWING

FIG. 1 is a graph showing an MSC function of a complete diffused noise field against frequency.

FIG. 2 is a block diagram showing a post-filter according to the present invention.

FIG. 3 is a block diagram showing a general configuration of a corrected Zelinski post-filter.

FIG. 4 is a block diagram showing a general configuration of a single-channel Wiener post-filter.

FIG. 5 is a graph showing the relationship between the directivity factor and frequency.

FIG. 6A is a graph showing a test result of the averaged SEGSNR calculated in two noise states at various signal-to-noise ratios.

FIG. 6B is a graph showing the test result of the averaged SEGSNR calculated in two noise states at various signal-to-noise ratios.

FIG. 7A is a graph showing a test result of the averaged NR calculated in two noise states at various signal-to-noise ratios.

FIG. 7B is a graph showing the test result of the averaged NR calculated in two noise states at various signal-to-noise ratios.

FIG. 8A is a graph showing a test result of the averaged LSD calculated in two noise states at various signal-to-noise ratios.

FIG. 8B is a graph showing the test result of the averaged LSD calculated in two noise states at various signal-to-noise ratios.

FIG. 9A is a graph showing an example of measurement corresponding to the typical Japanese utterance “Douzo Yoroshiku” (“How do you do?”) of a voice spectrogram in an environment of an automobile travelling at 100 km/h.

FIG. 9B is a graph showing the example of measurement corresponding to the typical Japanese utterance “Douzo yoroshiku” (“How do you do?”) of the voice spectrogram in the environment of an automobile travelling at 100 km/h.

FIG. 9C is a graph showing the example of measurement corresponding to the typical Japanese utterance “Douzo yoroshiku” (“How do you do?”) of the voice spectrogram in the environment of an automobile travelling at 100 km/h.

FIG. 9D is a graph showing the example of measurement corresponding to the typical Japanese utterance “Douzo yoroshiku” (“How do you do?”) of the voice spectrogram in the environment of an automobile traveling at 100 km/h.

FIG. 9E is a graph showing the example of measurement corresponding to the typical Japanese utterance “Douzo yoroshiku” (“How do you do?”) of the voice spectrogram in the environment of an automobile traveling at 100 km/h.

FIG. 9F is a graph showing the example of measurement corresponding to the typical Japanese utterance “Douzo yoroshiku” (“How do you do?”) of the voice spectrogram in the environment of an automobile traveling at 100 km/h.

FIG. 9G is a graph showing the example of measurement corresponding to the typical Japanese utterance “Douzo yoroshiku” (“How do you do?”) of the voice spectrogram in the environment of an automobile traveling at 100 km/h.

FIG. 9H is a graph showing the example of measurement corresponding to the typical Japanese utterance “Douzo yoroshiku” (“How do you do?”) of the voice spectrogram in the environment of an automobile traveling at 100 km/h.

### DETAILED DESCRIPTION OF THE INVENTION

An embodiment of the invention will be explained with reference to the drawings. In the description that follows, first, an explanation is given about a coherence function and an application thereof in a model noise field. Then, a hybrid post-filter in a diffused noise field is explained, and finally, the advantages of a post-filter according to the invention are described.

A complex coherence function defined by the equation below is widely used to characterize the noise field.

$$\begin{matrix}[ Expression 5 ] & \\ {Γ}_{{x}_{i} {x}_{j}} ( k , l ) = \frac{{φ}_{{x}_{i} {x}_{j}} ( k , l )}{\sqrt{{φ}_{{x}_{i} {x}_{i}} ( k , l ) {φ}_{{x}_{j} {x}_{j}} ( k , l )}} & ( 17 )\end{matrix}$$

where φxᵢxⱼ(k,l) is a cross-correlation spectral density between two signals xi(t) and xj(t); and φxᵢxᵢ(k,l) and φxⱼxⱼ(k,l) are autocorrelation spectral densities of the signals xi(t) and xj(t), respectively. A magnitude-squared coherence (MSC) function, which is another important means, is defined as a square of an amplitude of the complex coherence function given by MSC(k,l)=|Γxᵢxⱼ(k,l)|² used in this specification to analyze the noise field.

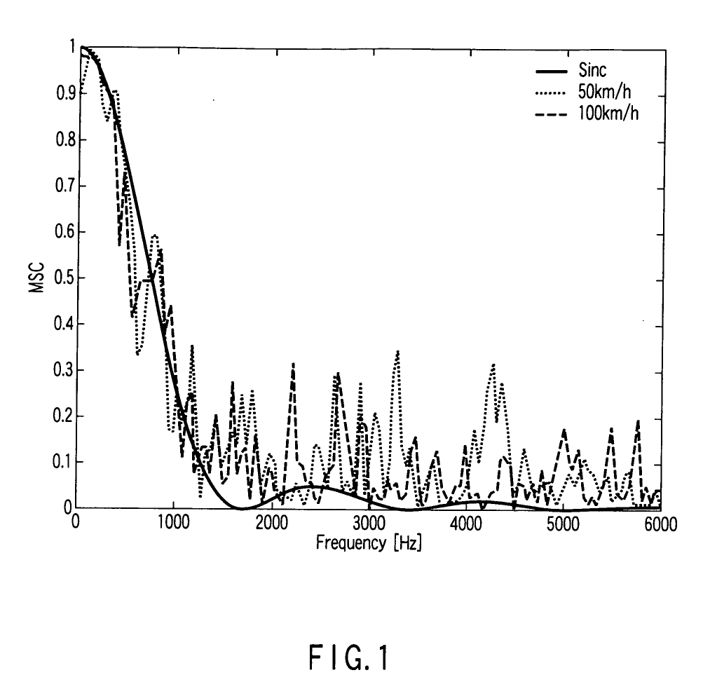

The diffused noise field, which is one of the basic assumptions in this specification, is shown as a rational model for many actual noise environments. The diffused noise field is characterized by the MSC function described below:

$$\begin{matrix}[ Expression 6 ] & \\ MSC ( k ) = {\vert \frac{sin ( 2 π kd / c )}{2 π kd / c} \vert}^{2} & ( 18 )\end{matrix}$$

where d is a distance between adjacent microphones and c is a sound velocity. An MSC function of a complete diffused noise field against frequency is shown in FIG. 1. From FIG. 1, several characteristics of the diffused noise field described below can be easily determined.
1. The MSC function is dependent on frequency but not on time.
2. Noise instances for different microphones are correlated high at low frequency and correlated low at high frequency.

In order to divide a spectrum into a low correlated portion and a high correlated portion, a transition frequency fₜ for dividing the two regions is selected as a first minimum value given as fₜ=c/(2d). Apparently, the sound velocity c is regarded as a constant, and therefore, the transition frequency is determined simply by the distance d between the two microphones.

In order to formulate the post-filter according to this invention, the following assumptions are made:
(1) A desired speech signal and noise are not correlated for each microphone.
(2) The power spectral density of noise is the same for each microphone.
(3) Noise instances for different microphones constitute diffused noise.

Actually, it has been confirmed that the first assumption is used for a normal voice signal processing, and the second and third assumptions are realized in many actual noise environments.

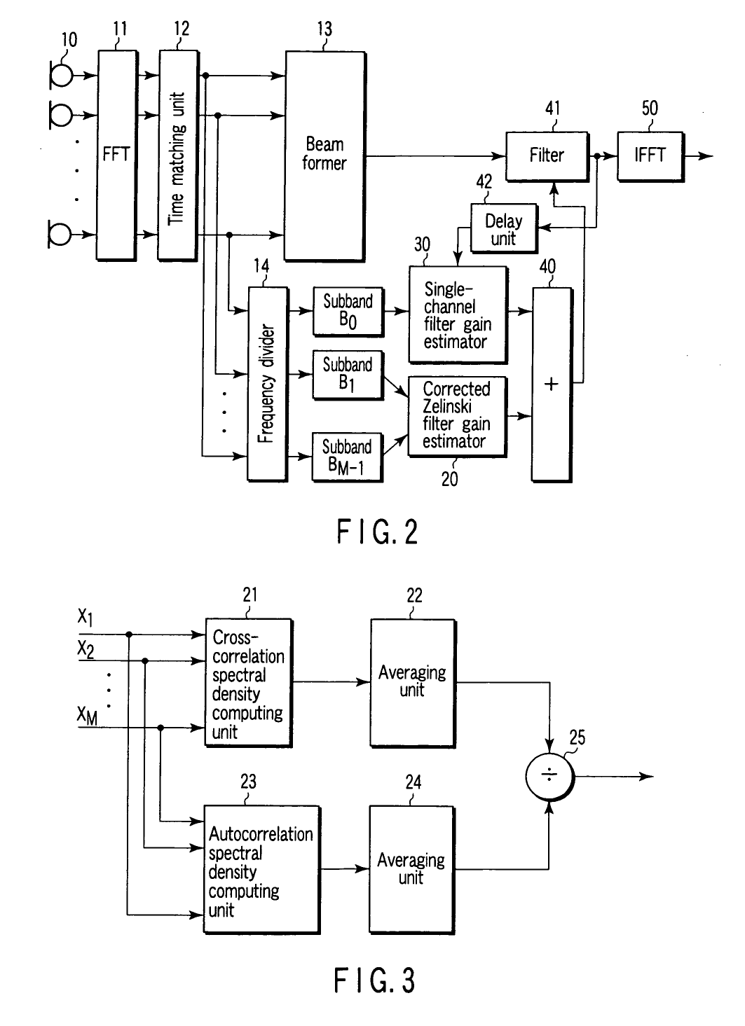

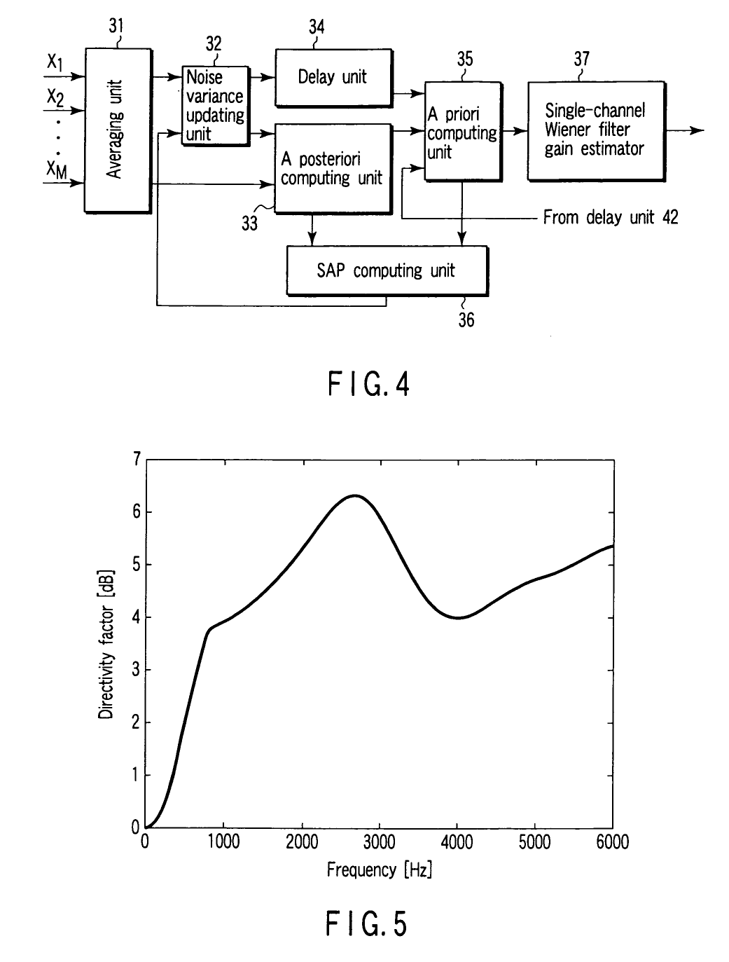

A hybrid post-filter for improving the noise reduction performance of the post-filter is explained below. As a post-filter, a corrected Zelinski post-filter for a high-frequency region and a single-channel Wiener post-filter for a low-frequency region are used. FIG. 2 is a block diagram showing a post-filter according to the invention. Also, FIG. 3 is a block diagram showing a general configuration of the corrected Zelinski post-filter. FIG. 4 is a block diagram showing a general configuration of the single-channel Wiener post-filter.

As shown in FIG. 2, the post-filter according to the invention includes a microphone array 10 (hereinafter sometimes referred to simply as “microphone”), a fast Fourier transformer 11, a time matching unit 12, a beam former 13, a frequency band divider 14, a corrected Zelinski filter gain estimator 20 (corrected Zelinski post-filter), a single-channel filter gain estimator 30, an adder 40, a filter 41, a delay unit 42 and an inverse fast Fourier transformer 50.

As shown in FIG. 3, the corrected Zelinski filter gain estimator 20 includes a cross-correlation spectral density computing unit 21, an averaging unit 22, an autocorrelation spectral density computing unit 23, an averaging unit 24 and a divider 25. Also, as shown in FIG. 4, the single-channel filter gain estimator 30 includes an averaging unit 31, a noise variance updating unit 32, an a posteriori signal-to-noise ratio computing unit 33, a delay unit 34, an a priori signal-to-noise ratio computing unit 35, a SAM computing unit 36 and a single-channel Wiener filter gain estimator 37 (single-channel Wiener post-filter).

In the aforementioned configuration, based on the assumption that the noise instances for the microphones 10 are not correlated to each other, a mean square error between the voice in the non-correlated noise field and the estimation thereof is required to be minimized. As described above, the autocorrelation and cross-correlation spectral densities of the multi-channel input contain the correlation noise component. In the case where the noise correlation used for estimating the autocorrelation and cross-correlation spectral densities of the multi-channel input is small, therefore, it is considered possible to suppress the performance reduction.

As shown in FIG. 1, the noise components of different microphones, which are not correlated in the diffused noise field, exist only in the frequencies not lower than the transition frequency ft. The transition frequency is determined in accordance with the distance between the microphones, and therefore, the microphones having different distances between elements are characterized by different transition frequencies. Specifically, non-correlated noise instances exist in different frequency regions in different microphones having different intervals between elements. Further, with regard to a given frequency, the noise instances are not correlated with each other only for specified microphones, but for all the microphones in general. As a result, the corrected Zelinski post-filter can be obtained by calculating the autocorrelation and cross-correlation spectral densities of the multi-channel input of the related microphone pair. This is specifically explained below.

The transition frequency is determined in advance in accordance with the microphone arrangement of the microphone array. Specifically, consider an M sensor array with sensors i and j (i, j≦M) distant by d ᵢⱼ from each other and having the intervals between elements. It has M(M-1)/2 microphone pairs for determining the transition frequency of M(M-1)/2. In the process, the transition frequency can be calculated as f_{t,ij}=c/(2dᵢⱼ). In this case, the intervals between mutual elements are the same for several microphones, and therefore, the transition frequency is also the same. In the case where M microphones are arranged equidistantly on the straight line, for example, the M(M-1)/2 microphones have (M-1) different element intervals, and therefore, (M-1) different transition frequencies indicated by fₜ¹, fₜ², . . . , fₜ^{M-1} can be determined. Incidentally, as long as no general applicability is lost, the relation between transition frequencies may be further assumed to be fₜ¹<fₜ²<, . . . , <fₜ^{M-1}. Incidentally, unless M microphones are arranged equidistantly or linearly, all the M(M-1)/2 microphone pairs can be arranged at different intervals, in which case M(M-1)/2 transition frequencies can be selected.

For example, the voice input from the microphone 10 is subjected to Fourier transform at the fast Fourier transformer 11. With regard to the signal after Fourier transform, the time shift of the input signals for the same voice between the microphones 10 is corrected by the time matching unit 12. In this case, the processes in the fast Fourier transformer 11 and the time matching unit 12 may be executed in reverse order.

Next, the temporally matched voice signals are input to the frequency band divider 14, which divides the entire frequency band into M subbands B₀, B₁, . . . , B_{M-1} at (M-1) different transition frequencies fₜ¹, fₜ², . . . , fₜ^{M-1}. Of the M subbands, the (M-1) subbands B₁, . . . , B_{M-1} are input to the corrected Zelinski filter gain estimator 20. The temporally matched voice signals are input also to the beam former 13 and after beam forming, input to the filter 41.

With regard to the (M-1) subbands input to the corrected Zelinski filter gain estimator 20, the cross-correlation spectral density is calculated by the cross-correlation spectral density computing unit 21, and the average value thereof is determined by the averaging unit 22. In the averaging operation in the averaging unit 22, not all the inputs but the autocorrelation (cross-correlation) spectral densities for the microphone pairs with the noise instances not correlated in the particular band are selected and averaged out. Also, the autocorrelation spectral density is calculated in the autocorrelation spectral density computing unit 23, and the average value thereof is determined in the averaging unit 24. Incidentally, in the cross-correlation spectral density computing unit 21 and the autocorrelation spectral density computing unit 23, the spectral density of the noise is determined in the manner described below.

Assume that the noise instances for the microphone pair Qm for the frequencies of the subband Bₘ (1≦m≦M-1) are not correlated. In this case, the autocorrelation and cross-correlation spectral densities of the multi-channel input are given from

φxixi(k,l)=φss(k,l)+φnn(k,l) (19)

φxixj(k,l)=φss(k,l) (20)

From these spectral densities, the spectral densities of the desired speech and the noise can be estimated.

Then, the auto and cross spectral densities averaged by the averaging units 22 and 24 are calculated by the divider 25 thereby to output a filter gain (gain function) in the high-frequency band. In this case, since the Zelinski post-filter determines the filter gain by averaging the autocorrelation (cross-correlation) spectral densities for all the microphone pairs, data with a high noise correlation (not covered by the assumption) is undesirably included. As a result, the estimation of the filter gain fails to be robust. In the corrected Zelinski post-filter, on the other hand, only data low in noise correlation (covered by the assumption) is selected as a set Qm and averaged within that range, resulting in a high robustness. In this case, the gain function of the corrected Zelinski post-filter can be given as

$$\begin{matrix}[ Expression 7 ] & \\ {G}_{mz} ( k , l ) = \frac{\frac{1}{\vert {Ω}_{m} ( k ) \vert} {\sum }_{\{ i , j \} ∈ {Ω}_{m} ( k ) \}} R \{ {φ}_{{x}_{i} {x}_{j}} ( k , l ) \}}{\frac{1}{\vert {Ω}_{m} ( k ) \vert} {\sum }_{\{ i , j \} ∈ {Ω}_{m} ( k ) \}} [ {φ}_{{x}_{i} {x}_{i}} ( k , l ) + {φ}_{{x}_{j} {x}_{j}} ( k , l ) ]} & ( 21 )\end{matrix}$$

In the foregoing description, the determination of the transition frequency is dependent only on the arrangement of the micro array, but not on the input signal. Also, the selection of the microphone pair included in the procedure of estimating the autocorrelation and cross-correlation spectral densities contributes to the reduction in the cost of calculation of the corrected Zelinski post-filter.

The subband B₀ from each microphone 10, on the other hand, is input to the single-channel filter gain estimator 30. In the case where the noise instances for all the microphones are correlated high, even the use of the corrected Zelinski post-filter would fail to estimate the autocorrelation spectral density of the desired voice signal from the autocorrelation and cross-correlation spectral densities of the multi-channel input. At low frequencies, therefore, the single-channel technique is employed to estimate the Wiener post-filter.

First, a subband B₀ input to the single-channel filter gain estimator 30 is averaged between channels by the averaging unit 31. The subband B₀ thus averaged is input to the noise variance updating unit 32 and the a posteriori signal-to-noise ratio computing unit 33. The noise variance updating unit 32 executes the update process based on the signals from the averaging unit 31 and the SAP computing unit 36, and outputs an estimated noise spectrum to the a posteriori signal-to-noise ratio computing unit 33 and the delay unit 34. The a priori computing unit 35 executes various calculating operations described in detail later from the a posteriori signal-to-noise ratio computing unit 33. The single-channel Wiener filter gain estimator 37, based on the signal from the a priori signal-to-noise ratio computing unit 35, outputs a filter gain (gain function) in the low-frequency band.

In the configuration described above, the gain function of the Wiener post-filter can be rewritten as follows:

$$\begin{matrix}[ Expression 8 ] & \\ \begin{matrix}{G}_{S} ( k , l ) = \frac{{φ}_{ss} ( k , l )}{{φ}_{ss} ( k , l ) + {φ}_{nn} ( k , l )} \\ = \frac{E [ {\vert S ( k , l ) \vert}^{2} ]}{E [ {\vert S ( k , l ) \vert}^{2} ] + E [ {\vert N ( k , l ) \vert}^{2} ]} \\ = \frac{{SNR}_{priori} ( k , l )}{1 + {SNR}_{priori} ( k , l )}\end{matrix} & ( 22 )\end{matrix}$$

where E[ ] is an expectation operator and SNRₚᵣᵢₒᵣᵢ(k,l) is an a priori signal-to-noise ratio defined as SNRₚᵣᵢₒᵣᵢ(k,l)=E[|S(k,l)|²]/E[|N(k,l)²].

The estimation of the a priori signal-to-noise ratio (SNRₚᵣᵢₒᵣᵢ(k,l)) calculated by the a priori signal-to-noise ratio computing unit 35 is updated by the decision directivity estimation mechanism described below.

$$\begin{matrix}[ Expression 9 ] & \\ {SNR}_{priori} ( k , l ) = α \frac{{\vert S ( k , l - 1 ) \vert}^{2}}{E [ {\vert N ( k , l - 1 ) \vert}^{2} ]} + ( 1 - α ) max [ {SNR}_{post} ( k , l ) - 1 , 0 ] & ( 23 )\end{matrix}$$

In Equation (23), α (0<α<1) is a forgetting factor, and SNRₚₒₛₜ(k,l) is an a posteriori signal-to-noise ratio calculated by the a posteriori signal-to-noise ratio computing unit 33 and expressed as SNRₚₒₛₜ(k,l)=|X(k,l)|²/E[|N(k,l)|²]. As a result, the decision directivity estimation mechanism described above considerably reduces the “musical noise”.

To improve the performance of the single-channel Wiener post-filter, the very important point here is to estimate the noise power spectral density E[|N(k,1)|²] with high accuracy. This noise power spectral density is estimated with the soft decision base approach described below.

E[|N(k,l)|²]=βE[|N(k,l)|²]+(1−β)E[|N(k,l)|²|X(k,l)] (24)

In Equation (24), β (0<β<1) is a forgetting factor for controlling an update rate of noise estimation.

As far as the presence of the voice is not determined, the second term on the right side of Equation (24) is estimated as a spectral density of the signal observed using Equation (25).

$$E [ {\vert N ( k , l ) \vert}^{2} \vert X ( k , l ) \vert ] = q ( k , l ) {\vert X ( k , l ) \vert}^{2} + ( 1 - q ( k , l ) E [ {\vert N ( k , l - 1 ) \vert}^{2} ] \qquad ( 25 )$$

In Equation (25), q(k,l) is a speech absence probability, and |X(k,l)|² is an average spectral density of the individual noise instances at each sensor.

$$\vert {\vert X\_ ( k , l ) \vert}^{2} = \frac{1}{M} {\sum }_{m = 1}^{M} {\vert Xm ( k , l ) \vert}^{2} \qquad [ Expression 10 ]$$

The reason why the average spectral density of individual noise instances at each sensor is calculated is that the concentration on one sensor would be liable to cause an erroneous measurement due to an estimation error. Assuming the complex Gauss statistical value model, the application of Bayes theorem and the theorem of stochastic total sum gives the speech absence probability according to the following formula.

$$\begin{matrix}[ Expression 11 ] & \\ q ( k , l ) = {( 1 + \frac{1 - {q}^{′} ( k , l )}{{q}^{′} ( k , l )} \frac{1}{1 + {SNR}_{priori} ( k , l )} exp ( \frac{{SNR}_{post} ( k , l ) {SNR}_{priori} ( k , l )}{1 + {SNR}_{priori} ( k , l )} ) )}^{- 1} & ( 26 )\end{matrix}$$

In Equation (26), q′ (k,l) is an a priori speech absence probability and selected at an appropriate value experimentally.

The filter gains (gain functions) in the high-frequency band and the low-frequency band determined as described above are added in the adder 40 and the result of addition is output to the filter 41. The filter 41 outputs the signal reduced in noise in the high-frequency band and the low-frequency band from the outputs of the beam former 13 and the adder 40 to the delay unit 42 and the inverse fast Fourier transformer 50. The inverse fast Fourier transformer 50 subjects the input signal to the inverse Fourier transform, and outputs it to a voice recognition unit, for example, in the subsequent stage. Also, the signal output to the delay unit 42 is used for calculating the gain function in the single-channel filter gain estimator 30.

The post filter according to this invention theoretically follows the framework of the multi-channel Wiener post-filter and can be regarded as the Wiener post-filter in the true sense of the word. The post filter indicated by Equation 22 in the low-frequency range is apparently a Wiener filter. In the high-frequency range, on the other hand, the noise instances used for estimation in the corrected Zelinski post-filter are not correlated, and therefore, the cross-correlation spectral density of the multi-channel input provides a more accurate autocorrelation spectral density estimation of the speech. Therefore, the corrected Zelinski post-filter employed in the high-frequency range can be regarded as a Wiener post-filter.

It should be noted that the post-filter according to the invention configured as described above provides a more general expression as an optimum post-filter for the microphone array. In the completely non-correlated noise field, the post-filter according to the invention becomes a Zelinski post-filter simply by setting the transition frequency to zero. In the noise field with all the noise instances completely correlated, the single-channel Wiener post-filter is realized simply by setting the transition frequency of the post-filter according to the invention to the highest frequency.

In order to confirm the effectiveness of the post-filter according to the invention in the diffused noise field, the post-filter according to the invention was compared with the Zelinski post-filter, the McCowan post-filter and other conventional post-filters including the single-channel Wiener post-filter in various vehicle noise environments. The beam former is first used for the multi-channel noise. The output of the beam former is further upgraded in function by the post-filter according to the invention. The performance is evaluated by objective and subjective means.

The configuration for the experiment is as follows:

In order to estimate the performance of the post-filter according to this invention in the actual vehicle environment, a linear array including three equidistantly arranged microphones having the element interval of 10 cm was mounted on a sun visor of a vehicle. The array is arranged about 50 cm away from the driver on the front of the driver.

Multi-channel noise was recorded for all the channels at the same time while the vehicle was traveling along a freeway at 50 and 100 km/h. The noise mainly includes engine noise, air-conditioner noise and road noise. A clear speech signal including 50 Japanese utterances was retrieved from ATR database. First, both the speech signal and noise were extracted again at 12 kHz with an accuracy of 16 bits. The clear speech signal and the actual multi-channel in-vehicle noise were mixed artificially at different global signal-to-noise ratios of −5 and 20 dB. Thus, multi-channel noise was generated. This generation procedure has the following advantages:
(1) The time delay is considered to have been ideally compensated for.
(2) The mixing conditions are positively measured, and therefore, the performance estimation using objective means is facilitated.

By comparing the theoretical sinc function shown in FIG. 1 with the measurement MSC function calculated by recording the actual noise instances, the effectiveness of the diffused noise field was investigated. It can be understood from FIG. 1 that in spite of an instantaneous change, the measurement MSC function follows the trend of the theoretical sinc function. This value satisfies the assumption of the diffused noise field used in the post-filter according to the invention.

The beam forming filter is realized by a super-directivity beam former providing a solution for the MVDR beam former in the diffused noise field. A gain function of the super-directivity beam former which is a function of the frequency k is given as

$$\begin{matrix}[ Expression 12 ] & \\ {W}_{MVDR} ( k ) = \frac{{Γ}_{MVDR}^{- 1} ( k ) A ( k )}{{A}^{H} ( k ) {Γ}_{MVDR}^{- 1} ( k ) A ( k )} & ( 27 )\end{matrix}$$

A directivity factor (DI) indicating the noise reduction capability of the array against the diffused noise source is expressed as

$$\begin{matrix}[ Expression 13 ] & \\ DI ( k ) = 10 \cdot {log}_{10} ( \frac{{\vert {W}_{MVDR}^{H} ( k ) A ( k ) \vert}^{2}}{{W}_{MVDR}^{H} ( k ) {Γ}_{diffuse} ( k ) {W}_{MVDR}^{H} ( k )} ) & ( 28 )\end{matrix}$$

A relation between this directivity factor and the frequency is shown in FIG. 5. It is apparent from FIG. 5 that the super-directivity beam former has no effect of suppressing the low-frequency noise component.

In order to estimate the post-filter according to the invention objectively, three objective voice quality measurements of a segment signal-to-noise ratio (SEGSNR), a noise reduction ratio (NR) and a log spectrum distance (LSD) were used as described below.

The segment signal-to-noise ratio (SEGSNR) is objective estimation means widely used for the noise reduction and the voice enhancement algorithm. SEGSNR is defined as the ratio between the power of clear speech and noise included in speech containing noise or noise included in a signal with noise reduced by the proposed algorithm, and given as:

$$\begin{matrix}[ Expression 14 ] & \\ SEGSNR = \frac{1}{L} {\sum }_{l = 0}^{L - 1} 10 \cdot {log}_{10} ( \frac{{\sum }_{k = 0}^{K - 1} {[ s ( lK + k ) ]}^{2}}{{\sum }_{k = 0}^{K - 1} {[ s\_ ( lK + k ) - s ( lK + k ) ]}^{2}} ) & ( 29 )\end{matrix}$$

where s( ), s_( ) are signals obtained by suppressing a reference speech signal and noise processed with the algorithm tested. Also, L and K designate the number of frames of the signal and the number of samples per frame (equal to the length of STFT), respectively.

The noise reduction ratio (NR) is used for estimating the noise reduction performance of the proposed algorithm. In the absence of a voice, NR is defined as a ratio between the power of an input containing noise and the power of a signal enhanced, and expressed as:

$$\begin{matrix}[ Expression 15 ] & \\ NR = \frac{1}{\vert Φ \vert} {\sum }_{l = Φ} 10 \cdot {log}_{10} ( \frac{{\sum }_{k = 1}^{K} {x}^{2} ( k , l )}{{\sum }_{k = 1}^{K} s\_ {( k , l )}^{2}} ) & ( 30 )\end{matrix}$$

where φ is a set of frames lacking a voice; |φ| is a density; and X(k,l) and s_(k,l) are noise and an enhanced speech signal, respectively.

The log spectrum distance (LSD) is often used to estimate the distortion of a desired voice signal. LSD is defined as the distance between the logarithmic spectrum of clear speech and the logarithmic spectrum of noise or a signal enhanced by the proposed algorithm, and given as:

$$\begin{matrix}[ Expression 16 ] & \\ LSD = \frac{1}{\vert Ψ \vert} {\sum }_{l ∈ Ψ} {( \frac{1}{K} {\sum }_{k = 0}^{K} {[ 10 \cdot {log}_{10} S ( k , l ) - 10 \cdot {log}_{10} S\_ ( k , l ) ]}^{2} )}^{\frac{1}{2}} & ( 31 )\end{matrix}$$

where ψ is a set of frames having a voice, and |ψ| is the base thereof. S(k,l) and S_(k,l) are spectra of a reference clear signal and an enhanced voice signal, respectively.

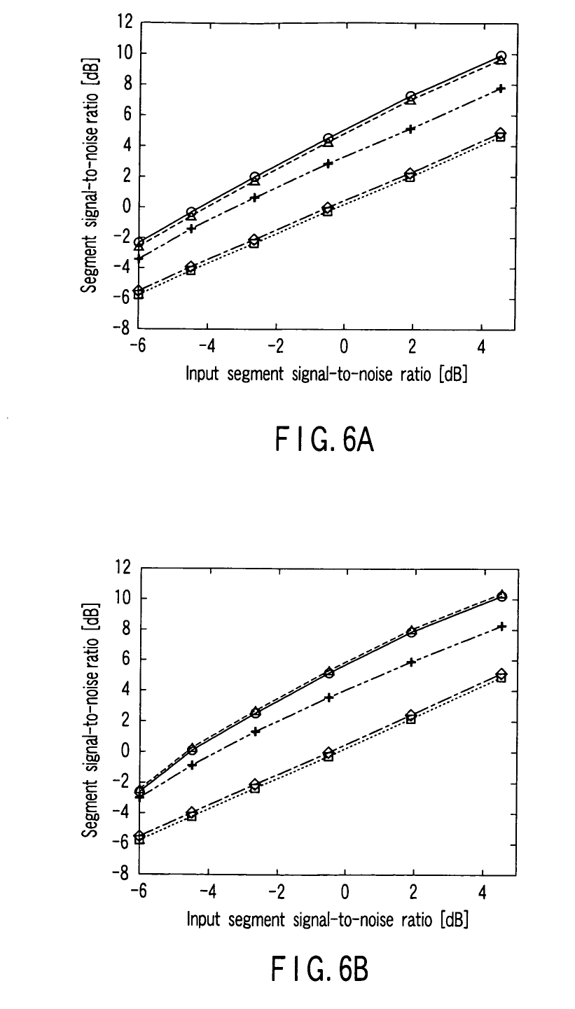

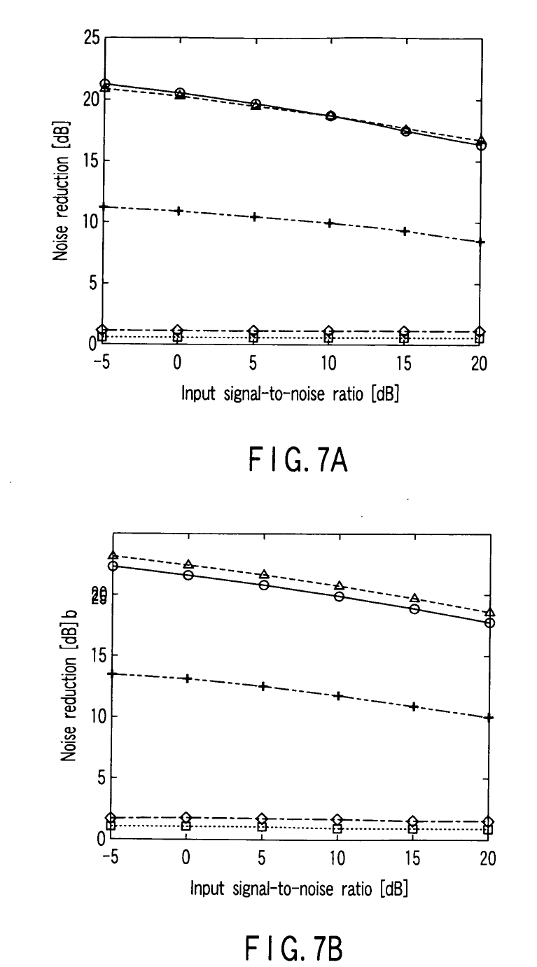

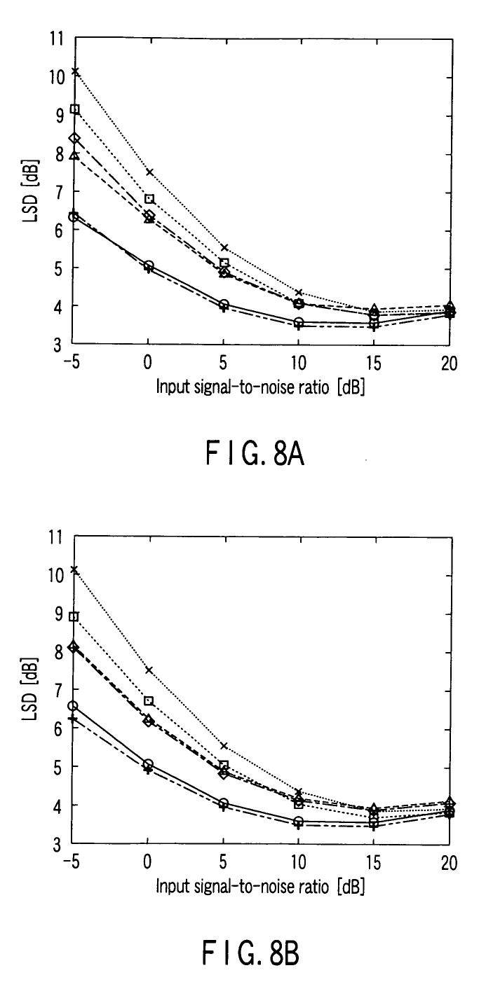

The result of the average SEGSNR and NR calculated at various signal-to-noise ratios in two noise states (50 km/h and 100 km/h) are shown in FIGS. 6A to 7B. Also, the result of LSD is shown in FIG. 8. The values of the experiment results are averaged over all the utterances in the respective noise states. The performance is estimated in the microphone recording, the beam former output and the output of the post-filter according to the invention. Incidentally, FIGS. 6A, 7A and 8A represent the cases in which the vehicle is travelling at 50 km/h; FIGS. 6B, 7B and 8B, the cases at 100 km/h. Also, in the symbols in the drawings, the rectangle designates the output of the beam former, the rhomb the output of the Zelinski post-filter, the (+) mark the output of the McCowan post-filter, the triangle the output of the single-channel Wiener post-filter, and the circle the output of the post-filter according to the invention. In FIG. 8, the symbol X designates the average logarithmic spectrum distance (LSD) of the signal as it is recorded without executing any process.

As shown in FIGS. 6A to 7B, the beam former alone and the Zelinski post-filter fail to exhibit a sufficient performance in suppressing the low-frequency noise component and produce no result of SEGSNR improvement or noise reduction. This indicates the result confirming the forgoing explanation. The McCowan post-filter using the appropriate coherence function of the noise field as a parameter improves SEGSNR considerably. In all the noise states, however, the single-channel Wiener post-filter produces the improvement of SEGSNR and NR higher than the Zelinski and McCowan post-filters. The post-filter according to the invention produces SEGSNR and NR equivalent to the single-channel post-filter under all the test conditions and exhibits the highest performance.

With regard to the LSD results shown in FIGS. 8A and 8B, the beam former alone and the Zelinski post-filter reduce the LSD for all the signal-to-noise ratios more with the filter than without the filter. The single-channel Wiener post-filter reduces the voice distortion at a low signal-to-noise ratio but increases the distortion at a high signal-to-noise ratio. The proposed method and the McCowan post-filter, on the other hand, indicate the lowest LSD for almost all signal-to-noise ratios.

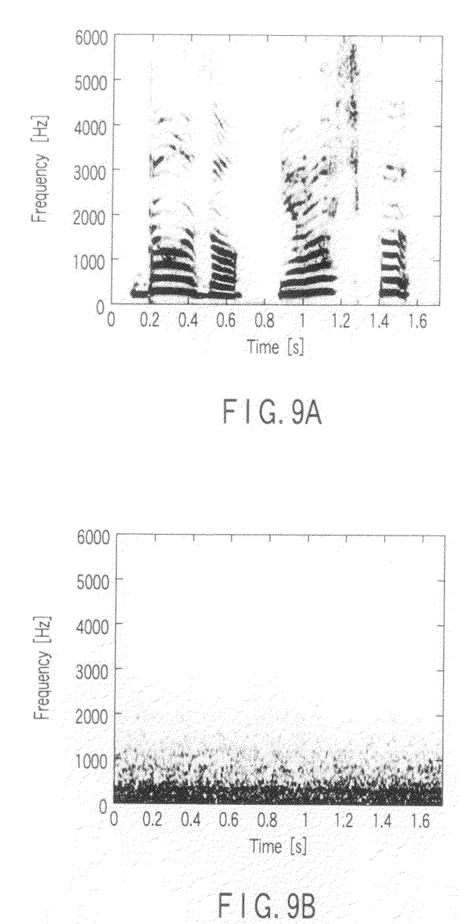

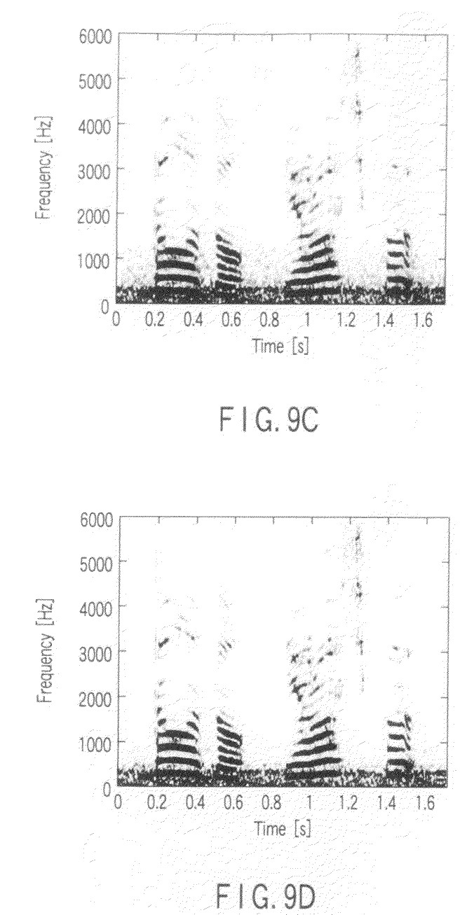

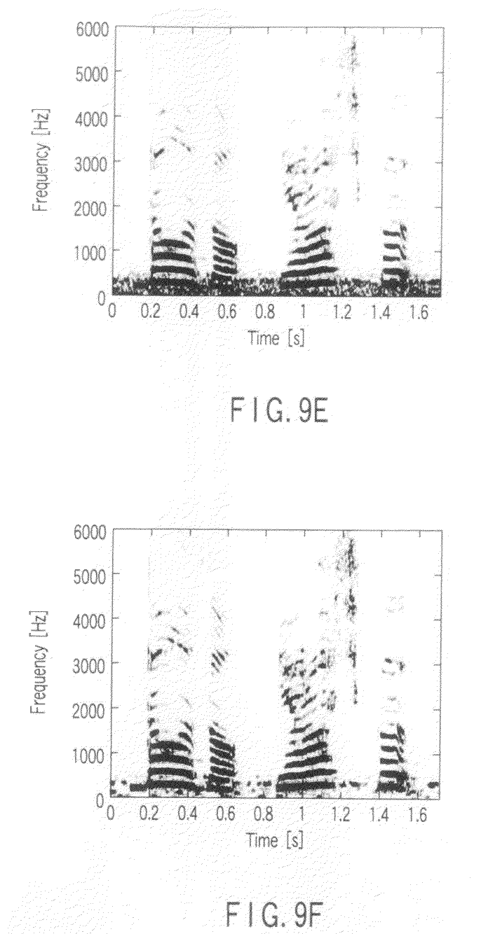

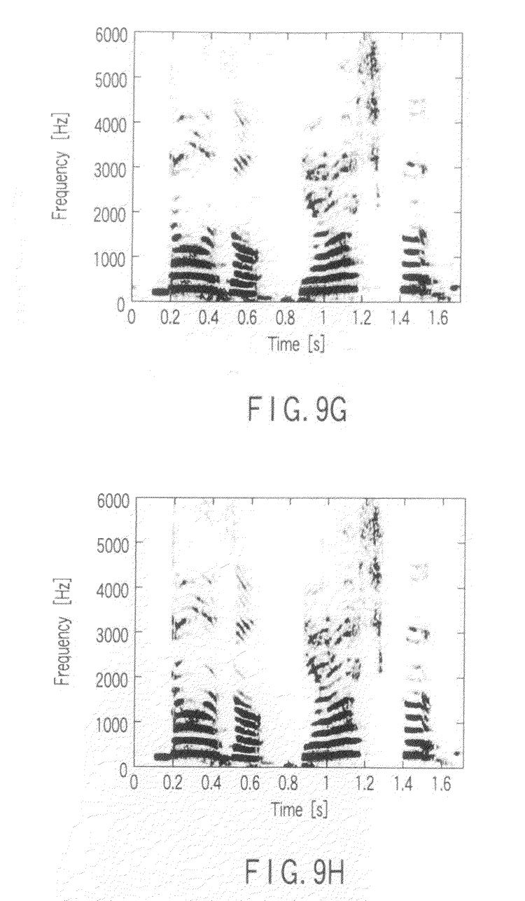

The subjective performance evaluation of the post-filter according to the invention was effectively conducted by using the voice spectrogram and by an informal hearing test. A typical example of measurement of the voice spectrogram corresponding to the Japanese “Douzo yoroshiku” meaning “How do you do?” in the environment inside the vehicle travelling at 100 km/h is shown in FIGS. 9A to 9H. FIGS. 9A to 9C show an original clear speech signal for a first microphone, noise for the first microphone and the noise signal (signal-to-noise ratio=10 dB) for the first microphone, respectively. FIG. 9D shows an output of the beam former. As shown in FIG. 5, the noise suppression has a weak point at low frequencies, and large low-frequency noise exists. Also, an output of the Zelinski post-filter shown in FIG. 9E is shown to provide a very limited performance at low frequencies because of the high correlation characteristic of the noise in the low-frequency region. FIG. 9F shows that the McCowan post-filter suppresses the noise also in the low-frequency region. Nevertheless, the residual noise exists due to the difference between the estimated coherence function and the actual coherence function. The single-channel Wiener post-filter, as shown in FIG. 9G, provides a voice distortion. FIG. 9H shows a post-filter according to the invention and indicates that the diffusive noise can be suppressed without adding the voice distortion. The informal hearing test has substantiated the superiority of the post-filter according to the invention over the other post-filters.

As described above, the basic assumption (diffused noise field) for the post-filter according to the invention in a practical environment is more rational than that for the Zelinski post-filter (non-correlated noise field). Therefore, the post-filter according to the invention is superior to the Zelinski post-filter. Further, the post-filter according to the invention succeeds in reducing the high correlation noise component of low frequencies.

The McCowan post-filter is determined based on the coherence function of the noise field. The performance, therefore, depends to a large measure on the accuracy of the assumed coherence function. The difference between the assumption and the actual coherence function brings about the performance deterioration. In the hybrid post-filter according to the invention, however, only the transition frequency is used to distinguish the correlated noise and the non-correlated noise. Regardless of the actual instantaneous value of the coherence function, the effect attributable to the error between the coherence functions is reduced.

The hybrid post-filter according to the invention is superior to the single-channel Wiener post-filter used in all the frequency bands. The single-channel Wiener post-filter based on the measurement of the noise characteristic cannot substantially meet the requirement of the unsteady noise source even with a soft decision mechanism. The multi-channel technique based on the estimation of the autocorrelation and cross-correlation spectral densities, however, provides a theoretically desirable performance also against the unsteady noise. The corrected Zelinski post-filter according to the invention provides this performance in a complete form in each frequency division of the high-frequency region.

As described above, according to the invention, a post-filter against the microphone array has been proposed assuming a diffused noise field. The post-filter according to the invention is configured by coupling the corrected Zelinski post-filter for the high-frequency region and the single-channel Wiener filter for the low-frequency region to each other.

The post-filter according to the invention, as compared with other algorithms, has the following advantages.
(1) Theoretically, the post-filter according to the invention is a Wiener post-filter, and therefore, follows the framework of the multi-channel Wiener post-filter.
(2) Actually, in the post-filter according to the invention, the noise is reduced, and the desired speech is effectively estimated as compared with other algorithms in various vehicle noise environments.

According to this invention, the high correlated noise and the low correlated noise in the diffused noise field can be effectively reduced.

The invention is not limited to the embodiments described above, and can be embodied in various modifications without departing from the spirit and scope of the invention. Further, the embodiments described above include various stages of the invention, and various inventions can be extracted by appropriate combinations of a plurality of constituent elements disclosed.

Also, according to the invention, the problems described in the related column for problem solution can be solved even if several constituent elements are deleted from all the constituent elements described in each embodiment, for example, and in the case where the effects of the invention described above can be obtained, the configuration with the particular constituent elements deleted can be extracted as an invention.

According to the invention, the high correlated noise and the low correlated noise in the diffused noise field can be effectively reduced.

What is claimed is:

1. A post-filter comprising:
a microphone array including at least two microphones to which a voice signal are input;
a beam former which forms the voice signal input from the microphone array;
a divider which divides a target sound containing noise input from the microphone array into at least two frequency bands at a predetermined frequency;
a first filter which estimates a filter gain with the noise correlated low between the microphones;
a second filter which estimates a filter gain of. one microphone of the microphone array or an average signal of the microphone array;
an adder which adds the outputs from the first filter and the second filter to each other; and
noise reducing part configured to reduce the noise based on the outputs from the adder and the beam former,
wherein the filter gain is estimated by one of the first and second filters in accordance with the frequency bands.

2. The post-filter according to claim 1, wherein the first filter is a corrected Zelinski post-filter and the second filter is a single-channel Wiener post-filter.

3. The post-filter according to claim 1,
wherein the first filter estimates the filter gain by determining a ratio between a cross-correlation spectral density and an autocorrelation spectral density, and
the second filter calculates an a priori signal-to-noise ratio based on an output signal of the post-filter and an a posteriori signal-to-noise ratio and estimates the filter gain based on the a priori signal-to-noise ratio.

4. The post-filter according to claim 1, wherein the frequency of the target sound divided by the divider is determined in accordance with the distance between the microphones.

5. The post-filter according to claim 4, wherein the first filter estimates the filter gain by selecting a microphone pair with the noise correlated low in each of a plurality of frequency bands after division.

6. The post-filter according to claim 1, wherein the divider divides the target sound into at least two frequency bands including a frequency band with the noise correlated high and a frequency band with the noise correlated low.
